(19) United States
(12) Patent Application Publication
(10) Pub. No.: US 2013/0136473 A1
(43) Pub. Date: May 30, 2013

(54) IMAGE FORMING APPARATUS

(71) Applicant: CANON KABUSHIKI KAISHA, Tokyo (JP)

(72) Inventors: Hiroshi Kita, Mishima-shi (JP); Shun-ichi Ebihara, Suntou-gun (JP)

(73) Assignee: CANON KABUSHIKI KAISHA, Tokyo (JP)

(21) Appl. No.: 13/686,156

(22) Filed: Nov. 27, 2012

(30) Foreign Application Priority Data
Nov. 29, 2011 (JP) 2011-261017

(51) Int. Cl. G03G 15/00

(52) U.S. Cl. CPC G03G 15/556
USPC 399/49

(57) ABSTRACT

An image forming apparatus includes an intermediary transfer member for carrying an image; a transferring device for transferring the image from the intermediary transfer member onto a sheet; a device for forming a toner patch for a density adjustment between adjacent sheets, in an area corresponding to between adjacent ones of sheets on the intermediary transfer member; a detector for detecting density of the patch; and a sheet interval density adjusting device for adjusting in real time a density/tone-gradation property of the image on the basis of a detection result of the density detector. The patch includes a density detection area, and an outer marginal portion having a density lower than that of the density detection area. The patch forming device changes at least one of a patch image density of the density detection area, a size of the marginal portion and a density of the marginal portion.

### FIELD OF THE INVENTION AND RELATED ART

The present invention relates to an image forming apparatus such as a copying machine, a printer, a facsimile machine, etc., which employs an electrophotographic image forming method or an electrostatic image recording method.

It is common practice to make an electrophotographic image forming apparatus form an image for adjusting the apparatus in image density (which hereafter may be referred to simply as “patch”), and adjust the apparatus in image formation setting according to the detected density of the patch, in order to keep the apparatus stable in image density.

Regarding the abovementioned adjustment in image density of an electrophotographic image forming apparatus, in the case of the image forming apparatus disclosed in Japanese Laid-open Patent Application 2001-109219, in order to prevent the image forming apparatus from being reduced in productivity by the operation for adjusting the apparatus in image density, the apparatus is successively adjusted in image density during a printing job, by forming a toner “patch” on a portion of the intermediary transfer member (belt), which corresponds in position to the interval between two sheets of recording medium which are being consecutively conveyed (which hereafter may be referred to simply as “sheet interval”), and detecting the image density of the patch. In the following description of the present invention, a toner patch formed on the sheet interval portion of the intermediary transferring member may be referred to simply as “sheet interval patch”. Further, a “sheet contact area” means the portion of the intermediary transferring member, which comes into contact with a sheet of recording medium (transfer medium) in the secondary transfer station. Further, a “sheet contact interval area” means an area of the intermediary transferring member, which is between two sheets of recording medium which are being consecutively conveyed by the intermediary transferring member.

In the case where an electrophotographic image forming apparatus is adjusted in image density during sheet intervals, the following problem will possibly occur. That is, a sheet interval patch is transferred onto the intermediary transferring member. Then, while it is conveyed through the secondary transfer station, it soils the peripheral surface of the secondary transfer roller by partially transferring onto the peripheral surface of the secondary transfer roller. As the peripheral surface of the secondary transfer roller is soiled by the toner, the sheet of recording medium conveyed through the secondary transfer station immediately after the soiling of the secondary transfer roller is soiled by the toner on the secondary transfer roller, on the opposite surface (back surface) of the sheet from the surface onto which the normal image is transferred. Further, as the toner transfers onto the peripheral surface of the secondary transfer roller, it functions as insulator, making it impossible for an image on the intermediary transferring member to be uniformly transferred onto a sheet of recording medium across the entirety of the sheet, which is conveyed immediately after the transfer of the toner onto the secondary transfer. That is, the transfer of the toner in the patch onto the secondary transfer roller is not desirable from this standpoint. In the case of Japanese Laid-open Patent Application 2001-109219, therefore, while a toner patch is conveyed through the secondary transfer station, a transfer electrical field, which is opposite in polarity from the normal transfer electrical field, that is, the electrical field for the normal printing operation, is created in the secondary transfer station to prevent the toner in the toner patch from transferring onto (and adhering to) the secondary transfer roller, in order to deal with the above described problems. In addition, after the passage of the toner patch through the secondary transfer station, an alternating electrical field is formed in the secondary transfer station to cause the toner having adhered to the secondary transfer roller to transfer back onto the intermediary transferring member, in order to prevent the secondary transfer roller from continuing to contaminate sheets of recording medium, on their back surfaces. Moreover, in order to prevent, in the first place, the secondary transfer roller from being contaminated, the second transfer roller is separated from the intermediary transferring member during the sheet interval, before the patch reaches the secondary transfer station. Then, the second transfer roller is placed in contact with the intermediary transfer roller as soon as the toner patch is conveyed out of the secondary transfer station.

However, a substantial number of image forming apparatuses having come into the market recently have been reduced in sheet interval, compared to the conventional image forming apparatuses, in order to make them higher in productivity, that is, in order to increase in the number of prints they can produce per unit length of time, while preventing the load to which driving components such as motors is subjected, from increasing, and attempting to reduce the apparatus in size and extend the apparatus in service life. In the case of such electrophotographic image forming apparatuses, the amount of sheet distance in terms of the recording medium conveyance direction is roughly several tens of millimeters. Thus, forming an alternating electrical field in the secondary transfer station, or keeping the second transfer roller separated from the intermediary transferring member, while the portion of the intermediary transferring member, which corresponds in position to the sheet interval, in the secondary transfer station, is rather difficult unless the image forming apparatus is reduced in image formation speed (which hereafter will be referred to as process speed), because the length of time it takes for the sheet interval portion of the intermediary transferring member to be moved through the secondary transfer station is very short. Generally speaking, the sheet interval patch is square and roughly 5-10 mm in the length of each edge. That is, it is very small compared to the width of a sheet of recording paper used for a printing job. Therefore, a sheet of recording medium is likely to be soiled by the toner in the toner patch on its back surface. Further, in the case where the back surface of a sheet of recording medium is soiled by the toner in the patch, the conspicuousness of the soiling is affected by the difference in color between the soiling and the sheet.

### SUMMARY OF THE INVENTION

Thus, the primary object of the present invention is to provide an image forming apparatus which is far less in terms of the conspicuousness of the soiling of the back surface of a sheet of recording medium, which is attributable to the toner from a sheet interval patch, and yet, is as excellent in productivity and stable in image density as any image forming apparatus in accordance with the prior art, or even superior in productivity and stability in image density to any image forming apparatus in accordance with the prior art.

According to an aspect of the present invention, there is provided an image forming apparatus comprising an intermediary transfer member for carrying an image formed by image forming means; secondary transferring means for transferring the image from said intermediary transfer member onto a recording material; toner patch forming means for forming a toner patch for a density adjustment between adjacent recording materials, in an area corresponding to between adjacent ones of recording materials in continuous image formation on said intermediary transfer member, by controlling said image forming means; density detecting means for detecting density information of the toner patch; and a sheet interval density adjusting means for adjusting substantially in real time a density/tone-gradation property of the image formed by said image forming means on the basis of a detection result of said density detecting means, wherein the toner patch includes a density detection area a density of which is detected, and a marginal portion provided at a outer marginal portion of the density detection area and having a density lower than that of the density detection area, and wherein said toner patch forming means changes at least one of a patch image density of the density detection area, a size of the marginal portion and a density of the marginal portion.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1 is a schematic sectional view of a typical image forming apparatus to which the present invention is applicable. It shows the general structure of the apparatus.

FIG. 2 is a block diagram of the image formation system of the image forming apparatus shown in FIG. 1. It shows the general structure of the system.

FIG. 3 is a schematic drawing for describing the image density sensor, as a part of a density adjusting automatic means, and shows how the density sensor works.

FIG. 4 is a schematic drawing for showing where on the intermediary transfer belt the toner patches for adjusting the image forming apparatus in image density are formed during sheet intervals, in the first embodiment.

FIG. 5 is a detailed drawing of one of the sheet interval patches formed on the intermediary transferring member in the first embodiment.

FIG. 6 is a table which shows the examples of the actual patch used in the experiments for finding the relationship between the structure of the sheet interval patch and the level of the soiling of the back surface of a sheet of recording medium.

FIG. 7 is a graph which shows the results of the experiments performed to find the relationship between the structure of the sheet interval patch and the level of the soiling of a sheet of recording medium.

FIG. 8 is a flowchart of the operational sequence for adjusting the image forming apparatus in image density, during a sheet interval.

FIG. 9 is a graph which shows the results of the experiments performed to find the relationship between the structure of the sheet interval patch and the level of the soiling of a sheet of recording medium.

FIG. 10 is a flowchart of the operational sequence for adjusting the image forming apparatus in image density during a sheet interval.

FIG. 11 is a drawing for describing the correlation between the color difference between recording medium and sheet interval patch, and the brightness of recording medium detected by the media sensor.

### DESCRIPTION OF THE PREFERRED EMBODIMENTS

Hereinafter, examples of an image forming apparatus to which the present invention is applicable is described in more detail with reference to the appended drawings.

The measurement, material, and shape of the structural components of the image forming apparatus in the following embodiments of the present invention, and the positional relationship among the structural components, are not intended to limit the present invention in scope. That is, the present invention is also applicable to image forming apparatuses different from the image forming apparatuses in the following embodiments of the present invention, in terms of the measurement, material, and shape of the structural components of the image forming apparatus, the positional relationship among them, and also, in the settings.

### Embodiment 1

### <Structure of Image Forming Apparatus>

First, the image forming apparatus in this embodiment of the present invention is described about its overall structure and operation.

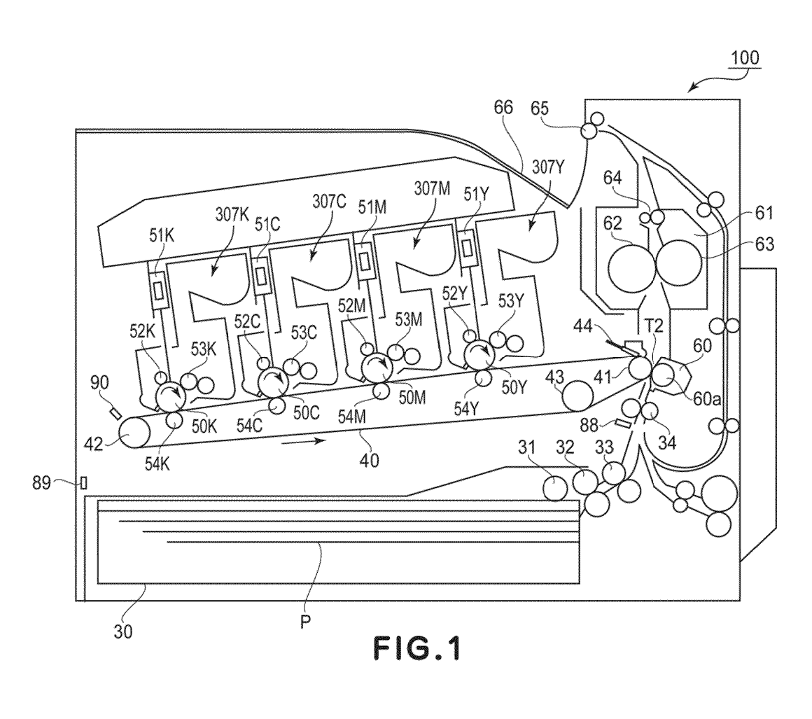

FIG. 1 is a schematic sectional view of the image forming apparatus 100 in this embodiment, and shows the general structure of the apparatus. The image forming apparatus 100 is a color image forming apparatus of the so-called tandem type, and employs an intermediary transferring member.

In this embodiment, the image forming apparatus 100 has a sheet feeding station 30, and four image formation stations 307, more specifically, image formation stations 307Y, 307M, 307C and 307K for forming yellow (Y), magenta (M), cyan (C) and black (B) toner images, which correspond to the number of developers which are different in color. Each image formation station 307 has an electrophotographic photosensitive member 50 (50Y, 50M, 50C or 50K) (which hereafter will be referred to simply as “photosensitive drum 50”), as an image bearing member, which is in the form of a drum. It has also laser-based exposing device 51 (51Y, 51M, 51C or 51K). Further, it has: a charge roller 52 (52Y, 52M, 52C or 52K, which is developing means); a development roller 53 (53Y, 53M, 53C or 53K, which is developing means); etc.

The image forming apparatus 100 has also an intermediary transferring member 40, primary transfer roller 54Y, 54M, 54C and 54K (as primary transferring means), and a secondary transfer station 60. The secondary transfer station 60 is provided with a secondary transfer roller 60a, which forms a secondary transferring portion T2 between itself and intermediary transferring member 40. The intermediary transferring member 40 is an endless belt, and is suspended and kept tensioned by a driving roller 42, a tension roller 42, and an auxiliary roller 43 (which is rotated by movement of belt 40), and is circularly movable in the direction indicated by an arrow mark. Further, the image forming apparatus 100 is provided with a cleaning means 44 for removing the toner remaining on the intermediary transferring member 40 after the secondary transfer.

Image formation signals are transmitted to the image formation stations 307 from a host computer, directly or through a network to which the host computer is connected, or transmitted to the image formation stations 307 (as the image forming means), from the control panel of the apparatus through a printer controller. In image formation station 307 (307Y, 307M, 307C or 307K), DC bias (as charging bias) is applied to the charge roller 52 (52Y, 52M, 52C or 52K) to uniformly charge the peripheral surface of the photosensitive drum 50 (50Y, 50M, 50C or 50K, respectively). Then, the uniformly charged portion of the peripheral surface of the photosensitive drum 50 (50Y, 50M, 50C or 50K) is exposed to a beam of laser light emitted by the laser-based exposing devices 51 (51Y, 51M, 51C or 51K) while being modulated with the image formation signals. Consequently, an electrostatic latent image is formed on the peripheral surface of each photosensitive drum 50. The electrostatic latent image is developed into a visible image, that is, an image formed of toner (developer) by the application of DC bias to the development rollers 53Y, 53M, 53C or 53K.

Then, DC bias as the primary transfer bias is applied between the intermediary transferring member 40 and photosensitive drum 50 through the primary transfer roller 54 (54Y, 54M, 54C or 54K), transferring (primary transfer) thereby the toner images, different in color, formed, one for one, on the photosensitive drums 50Y, 50M, 50C and 50K, onto the intermediary transferring member 40. In this embodiment, the process speed, that is, the moving speed of the intermediary transferring member 40, is 240 mm/sec. The toner used by this image forming apparatus is negative in electrical polarity. Thus, the primary transfer bias is positive DC bias.

A sheet P of recording medium is fed into the apparatus main assembly by a feed roller 31. Then, it is conveyed by a pair of feeding/retarding rollers 32 and a pair of conveyance rollers 33, to a pair of registration rollers 34, which is remaining stationary. As the sheet P strikes the pair of the registration rollers 34, it corrects itself in attitude. Then, it is conveyed, with preset timing, to the secondary transfer station 60, in which the toner images on the intermediary transferring member 40 are transferred onto the sheet P. While the toner images are transferred onto the sheet P (secondary transfer), positive DC bias, which causes a preset amount of transfer current to flow, is applied to the secondary transfer roller 60a. The amount by which the positive DC current is applied is adjusted according to the environment in which the image forming apparatus 100 is being used and the operational mode in which the apparatus is operated. During the sheet intervals which occur in a continuous printing job, and at the end of a job, however, negative DC bias is applied to the secondary transfer roller 60a. This application of the negative DC voltage is for electrically preventing the toner on the intermediary transferring member 40 from transferring onto the secondary transfer roller 60a while there is no sheet P of recording medium in the secondary transfer portion T2, that is, while the intermediary transferring member 40 is in contact with the secondary transfer roller 60a in the secondary transfer portion T2. After the secondary transfer, the toner remaining on the intermediary transferring member 40 is removed by the cleaning means 44.

Them, the sheet P of recording medium is conveyed to the fixing device 61 by the secondary transfer roller 60a of the secondary transfer station 60 and the intermediary transferring member 40. In the fixing device 61, the toner images on the sheet P are fixed to the sheet P while the sheet P is conveyed through the fixing device 61, remaining pinched between the fixation roller 62 and pressure roller 63 of the fixing device 61. After being conveyed through the fixing device 61, the sheet P is conveyed further by a pair of discharge rollers 64 for the fixing device 61, and then, is discharged by a pair of discharge rollers 65 into a delivery tray 66 in a manner to be layered in the delivery tray 66. If a two-sided print command is given by the printer controller, the sheet P is reversed in its conveyance direction by the pair of discharge rollers 65, so that it is conveyed for the second time, to the pair of registration rollers 34, which is kept stationary, through a sheet conveyance passage for the two-sided printing (which is at right end of apparatus in FIG. 1).

Since the image forming apparatus 100 is used in various environments, it is equipped with various sensors for ensuring that the image forming apparatus 100 outputs satisfactory prints regardless of the environment in which it is operated. The typical sensors are a media sensor 88, a temperature/humidity sensor 89, and a density/color sensor 90 (90a, 90b) (which hereafter will be referred to as “density sensor”). The media sensor 88 is positioned upstream of the pair of registration rollers 34, and detects such information as the degree of brightness of the sheet P of recording medium, degree of roughness (flatness) of the sheet P, and the like, while the sheet P is temporarily kept stationary by the registration rollers 34. Then, the media sensor 88 sends the information (degree of flatness, etc.) to the control section (which hereafter will be referred to as “CPU”) of the image forming apparatus 100. Based on this information, the CPU determines the type of the sheet P, and selects the optimal printing mode for the sheet P. The temperature/humidity sensor 89 is positioned next to the inward surface of the left wall of the apparatus main assembly (as seen from front side of apparatus main assembly), and monitors the internal and ambient temperature and humidity of the image forming apparatus 100. Generally speaking, an electrophotographic image forming apparatus is sensitive to temperature and humidity. Therefore, the condition under which an electrophotographic image forming apparatus is operated, for example, the settings for the charge bias and transfer bias, are adjusted each time temperature/humidity information is sent to the CPU. The density sensor 90 is an optical sensor for detecting color difference and image density. The image forming apparatus 100 is provided with two density sensors 90, which are aligned in the direction perpendicular to the direction in which the sheet P of recording medium conveyed by the intermediary transferring member 40.

### <Block Diagram of Control System of Image Forming Apparatus>

Next, the structure of the control system of the image forming apparatus in this embodiment is described.

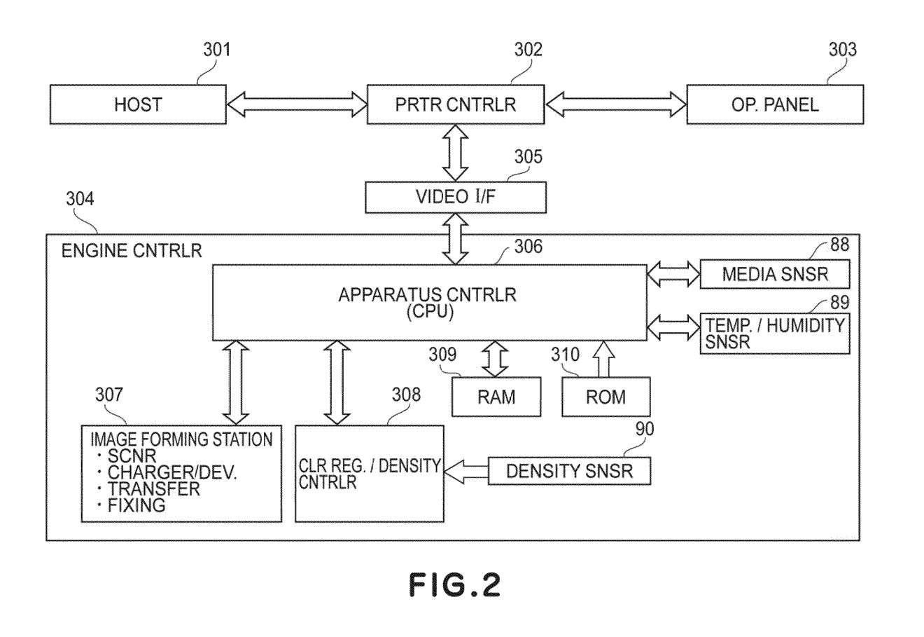

FIG. 2 is a block diagram of the control system of the image forming apparatus in this embodiment. The printer controller 302 is enabled to communicate with the host computer 301 or control panel 303, and also, with the engine control section 304. The printer controller 302 receives a normal print command and information about the image to be formed, from the host computer 301 or control panel 303. Then, it converts the image information into bit data by analyzing the information, and sends, per print (image), a print reservation command, a print start command, and video signals, to the engine control section 304, through the video interface 305.

First, the printer controller 302 sends a print reservation command to the engine control section 304 in response to the print command from the host computer 301. Next, as the image forming apparatus 100 becomes ready for printing, the printer controller 302 sends a print start command to the engine control section 304. As the engine control section 304 receives the print start command from the printer controller 302, it starts a printing operation. More concretely, the CPU 306 controls the engine control section 304 to make the image forming apparatus 100 carry out the printing operation for printing the chosen image, based on the information it received from the printer controller 302 through the video interface 305. Further, the CPU 306 plays the role of controlling the above described various sensors. For example, the CPU 306 plays the role of the toner patch forming means which forms the toner patch (sheet interval patch) to be detected by the density sensor 90 to adjust the image formation station (image forming apparatus) in the toner patch density level, by controlling the image formation station 307 and density control section 308. Here, a term “sheet interval” means the portion of the intermediary transferring member 40, which is between the portion of the intermediary transferring member 40, which comes into contact with the first of the two consecutively conveyed sheets of recording medium, in the secondary transfer station, and the portion of the intermediary transferring member 40, which comes into contact with the second sheet of recording medium. That is, it means the portion of the intermediary transferring member 40, which corresponds to the sheet interval.

Further, the CPU 306 looks up and renews the contents of a RAM 309 or a ROM 310 during an image forming operation or a density adjusting operation. The RAM 309 stores the results of the detection by the density sensor 90, for example, and the ROM 310 stores the values of the settings for the image formation station 307 for each printing mode.

### <Structure of Density Sensor as Means for Detecting Density Level of Sheet Interval Patch>

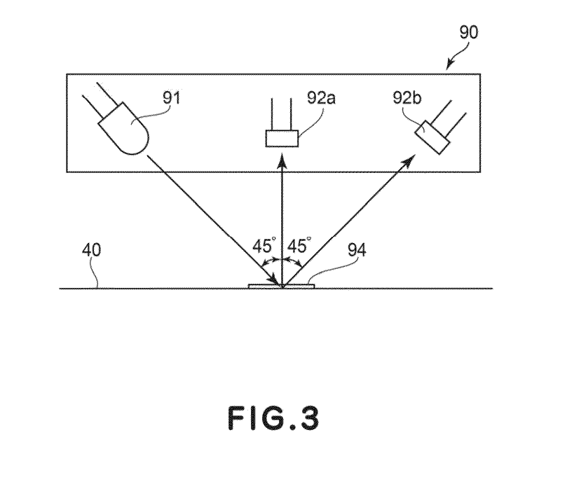

Next, referring to FIG. 3, the density sensor 90, which is the means for detecting the density level of the sheet interval patch, that is, a toner patch formed on the sheet interval portion of the intermediary transferring member 40 in order to adjust the image forming apparatus in image density during a continuous image forming operation (in which multiple sheets of recording medium are continuously conveyed), is described in detail about its structure.

The density sensor 90 is positioned so that it directly faces the intermediary transferring member 40 and the sheet interval patch 94. The light emitting element 91 in this embodiment, which is for illuminating the sheet interval patch, is an infrared light emitting diode SIR-34ST3F (product of Rohm Co., Ltd.). Light sensing elements 92a and 92b, which are sensitive to infrared light, are photo-transistors RPT-37PB3F (product of Rohm Co., Ltd.) The light emitting element 91 is positioned so that the beam of infrared light it projects hits the surface of the intermediary transferring member 40, at an angle of 45° relative to the direction perpendicular to the surface of the intermediary transferring member 40. The light sensing element 92a is positioned so that it will be straight above the center line of the sheet interval patch 94 on the intermediary transferring member 40 in terms of the widthwise direction of the intermediary transferring member 40, whereas the light sensing element 92b is positioned so that the angle between the direction perpendicular to the surface of the intermediary transferring member 40 and the line connecting the centerline of the intermediary transferring member 40 and the light sensing element 92b becomes −45°. The light sensing elements 92a and 92b catch the portion of the beam of light, which was regularly reflected by the surface of the intermediary transferring member 40, and the portion of the beam of light, which was regularly reflected by the surface of the sheet interval patch 94 on the intermediary transferring member 40, and also, the portion of the beam of light, which was irregularly reflected by the surface of the intermediary transferring member 40, and the portion of the beam of light, which was irregularly reflected by the surface of the sheet interval patch 94 on the intermediary transferring member 40. By detecting both the intensity of the regularly reflected portion of the beam of light, and the intensity of the irregularly reflected portion of the beam of light, it is possible to detect the density of the sheet interval patch 94 across a wide range density, from the high level of density to the low level of density.

### <Positioning of Sheet Interval Patch>

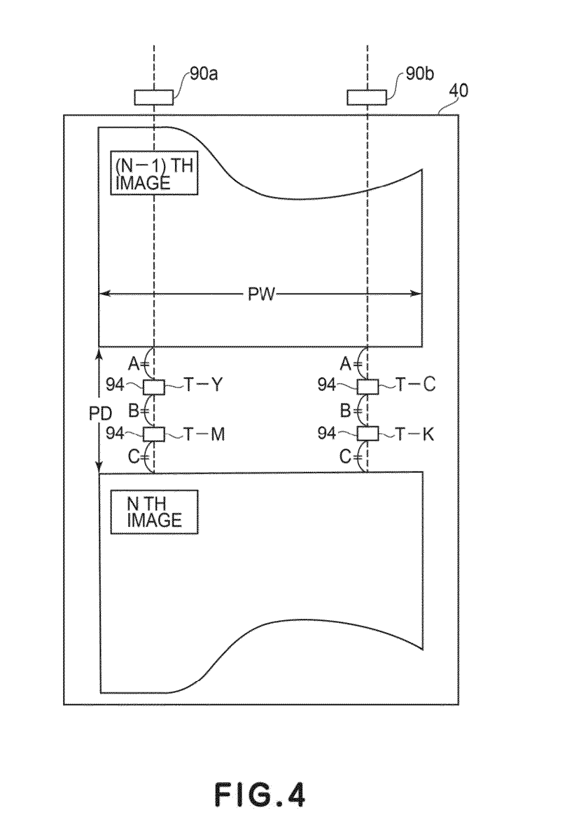

FIG. 4 is a drawing of the sheet interval patches 94 on the portion of the intermediary transferring member 40, which is between the N-th sheet of recording medium and the (N+1)-th sheet of recording medium. Referring to FIG. 4, the sheet interval patches 94 are formed on the intermediary transferring member 40 by the above described toner patch forming means. More specifically, the CPU 306 controls the toner patch forming means so that the toner patch forming means forms the sheet interval patches 94 on the peripheral surface of the photosensitive drum 50, which each image formation station has, based on the information about each toner patch, with such timing that the sheet interval patches 94 will be transferred onto the portion (sheet interval portion) of the intermediary transferring member 40, which corresponds to the sheet interval between the (N−1)-th sheet and N-th sheet in a continuous printing job. Each sheet interval patch 94 is formed so that the beam of infrared light emitted by the density sensor 94 hits the center of the sheet interval patch 94. More specifically, four sheet interval patches 94 are formed for yellow, magenta, cyan, and black colors, one for one, so that the beam of infrared light emitted by the density sensor 90a hits the center of the yellow sheet interval patch (T-Y) and the center of the magenta sheet interval patch (T-M), whereas the beam of infrared light emitted by the density sensor 90b hits the center of the cyan sheet interval patch (T-C) and the center of the black sheet interval patch (T-K). The positioning of the sheet interval patches 94 in terms of the recording medium conveyance direction is as follows.

Referring to FIG. 4, a referential code PD stands for the distance between the (N−1)-th sheet of recording medium and the N-th sheet. A referential code A stands for the distance between the (N−1)-th sheet and the sheet interval patch 94(T-Y), that is, the upstream sheet interval patch of the two sheet interval patches 94(T-Y) and 94(T-M) aligned in the recording medium conveyance direction, and a code B stands for the distance between the upstream sheet interval patch 94(T-Y) and downstream sheet interval path (T-M), and also, for the distance between the upstream sheet interval patch 94(T-C) and downstream 94(T-K). Further, a referential code C stands for the distance between the downstream sheet interval patch 94(T-M) and the N-th sheet, and also, for the distance between the downstream sheet interval patch 94(T-K) and the N-th sheet. The four sheet interval patches 94 are formed (positioned) so that the distances A, B, and C become the same in value (A=B=C). In terms of the direction perpendicular to the recording medium conveyance direction, the four sheet interval patches 94 are formed so that they will be within the path PW of the narrowest sheet of recording medium conveyable through the image forming apparatus 100, for the reason that the density sensors 90 (90a, 90b) double as color deviation correction sensors, and therefore, even when the narrowest sheet of recording medium (which has width of PW) conveyable through the image forming apparatus 100 is conveyed, the density sensors 90 have to properly function for color deviation correction.

### <Soiling of Back Surface of Sheet of Recording Medium by Toner of Sheet Interval Patch>

In the case of the image forming apparatus 100 in this embodiment, the sheet interval PD is 55 mm, which is less than the length 75.4 of the circumference of the secondary transfer roller 60a. Therefore, if the peripheral surface of the secondary transfer roller 60a is soiled by the sheet interval patches 94, it is possible that the N-th sheet of recording medium, on which an image is formed immediately after the soiling of the secondary transfer roller 60a, is soiled on its back side. Also in the case of the image forming apparatus 100 in this embodiment, negative DC bias, which is −50 V (opposite in polarity from bias applied during normal operation) is applied to the secondary transfer roller 60a while the sheet interval portion PD of the intermediary transferring member 40 is conveyed through the secondary transfer portion T2. Thus, the amount by which the toner on the intermediary transferring member 40 transfers onto the secondary transfer roller 60a while the intermediary transferring member 40 is pressed upon the secondary transfer roller 60a without the presence of a sheet of recording medium between itself and secondary transfer roller 60a, is reduced by the electrostatic repulsion of the toner from the intermediary transferring member 40. However, it is impossible to repel the entirety of the toner particles as they are physically transferred onto the secondary transfer roller 60a. Therefore, the image forming apparatus 100 in this embodiment forms such a sheet interval patch that makes the image forming apparatus 100 output a print, the back surface soiling of which attributable to the transfer of the toner from the secondary transfer roller 60a is as inconspicuous as possible.

Further, after the completion of each printing job, the image forming apparatus 100 is idled (second transfer roller 60a is rotated) in order to remove the toner on the secondary transfer roller 60a by causing the toner to transfer back onto the intermediary transferring member 40. That is, in the secondary transfer roller cleaning process to be carried out while the image forming apparatus 100 is idled after the completion of each printing job, the toner particles on the secondary transfer roller 60a are made to transfer back onto the intermediary transferring member 40 regardless of their polarity, that is, whether the toner particles are normally charged or reversely charged. More concretely, the negative and positive DC biases are alternately applied for the length of time equivalent to one full rotations of the secondary transfer roller 60a, while reducing the bias in absolute value, until each of the positive and negative DC voltage is applied for the length of time equivalent to three full rotations of the secondary transfer roller 60a; the secondary transfer roller 60a is rotated a total of six full turns, while changing the voltage in polarity for every full turn. When the image forming apparatus 100 was operated in the environment which was normal in temperature and humidity, −3300 V, +1200 V, −2100 V, +800 V, −330 V and +300 V of DC voltages were sequentially applied as DC bias to the secondary transfer roller 60a.

### <Structure of Sheet Interval Patch>

Next, the structure of the sheet interval patch 94, which is the primary feature of the present invention that characterizes the present invention.

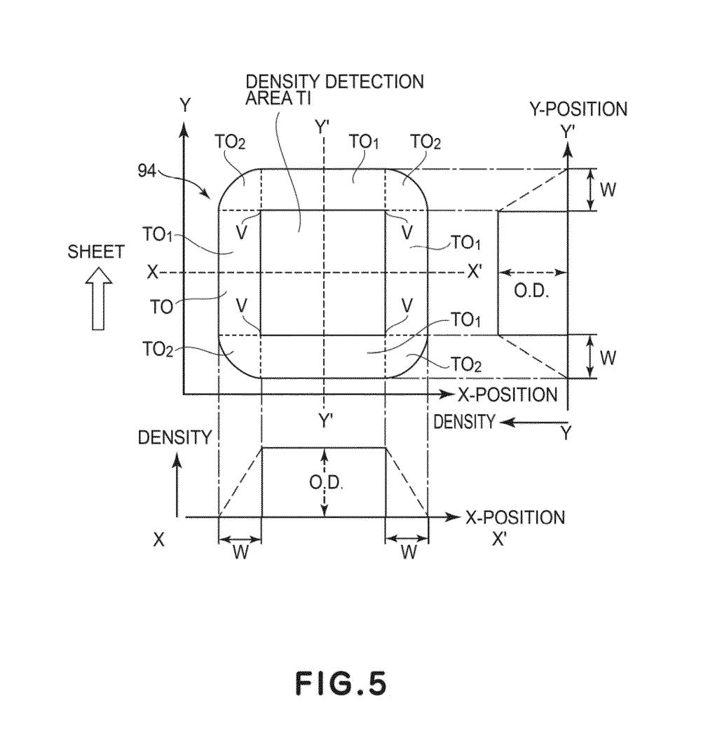

FIG. 5 is a schematic drawing of the sheet interval patch 94 to be formed on the intermediary transferring member 40 used by the image forming apparatus 100 in this embodiment. It shows the structure of the sheet interval patch 94. The direction indicated by an arrow mark Y is the same as the direction in which a sheet P of recording medium is conveyed. The area of the sheet interval patch 94, which is designated by a referential code TI is the area (density detection area) necessary for the density sensors 90 to precisely detect the density of the sheet interval patches 94. In the case of the image forming apparatus 100 in this embodiment, this area TI is square and is 10 mm×10 mm in size. The density sensors 90 samples multiple times the outputs in the density detection area TI, and the CPU 306 samples multiple times the output of the density sensors 90, which correspond in position to the density detection area TI, and averages the outputs. This procedure compensates for the nonuniformity, in density, of the sheet interval patch 94, and also, the random noises attributable to the density sensors 90 themselves, and therefore, makes it possible for the density of the sheet interval patches 94 to be detected at a higher level of accuracy. Further, each sheet interval patch 94 is provided with four rectangular portions TO1 and four quadrant portions TO2. Each rectangular portion TO1 is an extension of the density detection area TI by such a distance that will be described later. Each quadrant portion TO2 is in the form of a fan, the apex of which coincides with one of the four corners of the density detection area TI, and its radius is equal to the width W of the rectangular portion TO1. These areas, that is, the peripheral portions TO of the sheet interval patch 94, are formed in such a manner that their density linearly reduces, with the reflection density of the inward most side, that is, the portion next to the density detection area TI, being equal to the reflection density O.D. of the density detection area TI (which hereafter will be referred to as “O.D._{TI}”). More concretely, the sheet interval patch 94 is formed so that its peripheral portions TO linearly reduce in reflection density from the O.D._{TI}, which is equal to the reflection density of the density detection area TI, to zero, in proportion to the distance W from the edge of the density detection area TI. The reason why the sheet interval patch 94 was formed as described above is that human eyesight is such that the more gradual the changes in the difference in brightness between the center of an object and the peripheral portion of the object, the less it is likely to recognize the difference in density. Further, in the case of an electrophotographic image forming apparatus, while an electrostatic latent image on the photosensitive drum 50 is developed into a visible image with the use of toner, toner tends to collect to the trailing end portion of the electrostatic latent image. This collection of toner, that is, the increase in density, which occurs across the downstream end portion of the latent image, contaminates the secondary transfer roller 60a. Thus, from the standpoint of preventing this type of contamination of the secondary transfer roller 60a, forming the sheet interval patch 94 so that the peripheral portions TO of the sheet interval patch 94 gradually reduce in density is thought to be effective in making the soiling of the back surface of a sheet of recording medium as inconspicuous as possible.

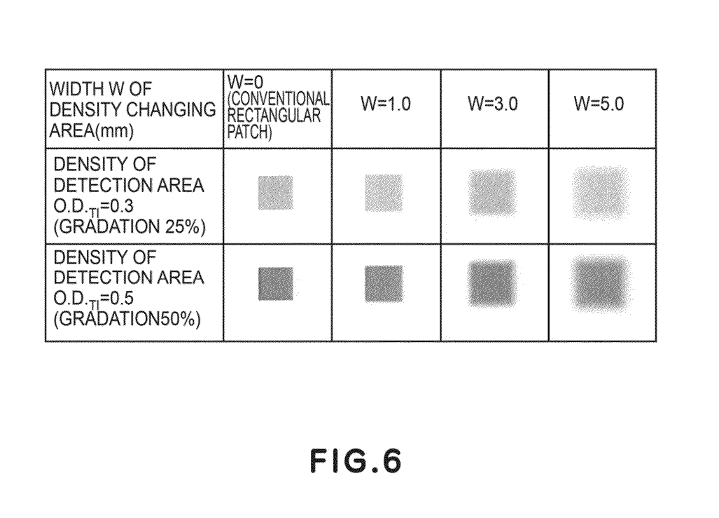

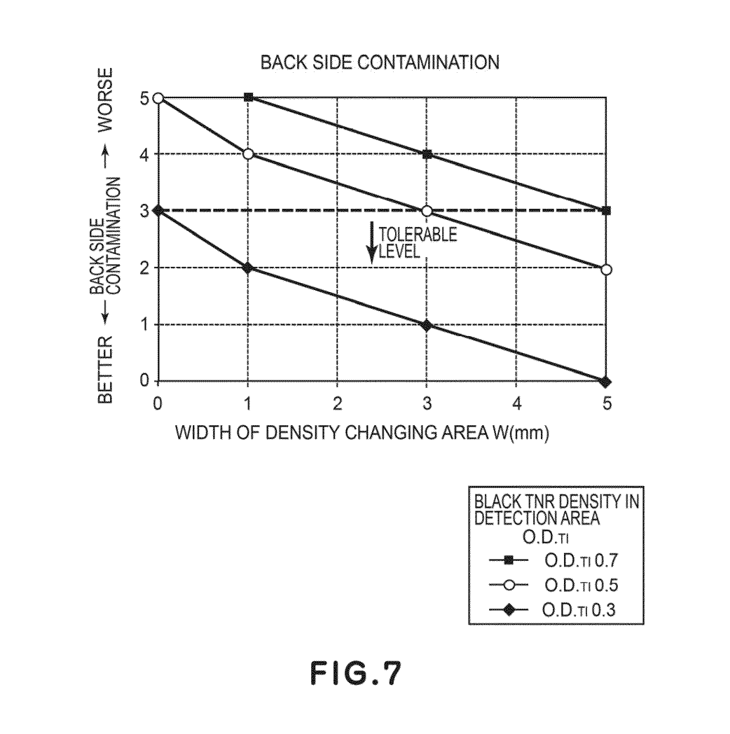

Next, referring to FIGS. 6 and 7, the results of the experiments carried out to test these theories are described. In the experiments, sheet interval patches 94, which are different in the O.D._{TI} and the width W of the peripheral portions TO were formed on the intermediary transferring member 40. Shown in FIG. 7 are the results of the experiment in which the sheet interval patches 94 described above were compared in terms of the level of back surface soiling of a sheet of recording medium (which hereafter will be referred to simply as “back surface soiling”) after one full turn of the secondary transfer roller 60a after a given portion of the secondary transfer roller 60a moved past (came into contact with) the intermediary transferring member 40. FIG. 6 shows the examples of sheet interval patches 94 used in the comparative experiments. As will be evident from the images of the sheet interval patches 94, the greater the width W of the peripheral portions TO of the sheet interval patch 94, the less (weaker) the contrast in density between the sheet interval patches 94 and the portions of a sheet of recording medium, which surround the sheet interval patch 94. Incidentally, the values of the O.D._{TI} given in FIG. 7 are density values of the center portion T1 of the sheet interval patch 94 obtained when the these patches were normally transferred onto a sheet of recording medium (paper). They are not the density of the soiled portion of the back surface of a sheet of recording medium conveyed immediately after the soiling of the secondary transfer roller 60a. The sheets of recording medium (paper) used as the recording medium were sheets of copy/laser printer paper CS814 of size A4 (product of Canon Co., Ltd.), and the device used to measure the sheet interval patches 94 in density was a density measuring device RD-918 (product of X-Rite Co., Ltd.). Further, regarding the vertical axis of the graph in FIG. 7, which presents visual ranking of the back surface soiling, a level 3 is the highest permissible level of back surface soiling, and a level 0 correspond to the case in which the back surface soiling is virtually undetectable.

If two sheet interval patches 94 are the same in density, the one, the peripheral portions of which are greater in width W results in the less conspicuous back surface soiling. On the other hand, if two sheet interval patches 94 are the same in the width W of their peripheral portions TO, the one which is lower in density is better in terms of the back surface soiling. If it is seen from a different angle, in the case of a sheet interval patch 94, the rectangular portions (TO) are conventional (W=0), when the reflection density O.D._{TI} of the sheet interval patch 94 is greater than 0.3, the back surface soiling exceeds the limit. In comparison, if the sheet interval patch 94 is formed so that width W becomes five (W=5), a sheet interval patch, the O.D._{TI} of which is as high as 0.7, can be keep within the permissible range in terms of the back surface soiling. Thus, it can be said that when the O.D._{TI} is 0.3, the image forming apparatus 100 is so good in print quality that the back surface soiling is virtually impossible to detect. That is, the sheet interval patch 94 can be widened in the density range, and therefore, the CPU is afforded more latitude when it controls the image forming apparatus 100 in density during sheet intervals. Further, it becomes possible to make the multiple sheet interval portions of the intermediary transferring member 40 different in the density/tone pattern of the sheet interval patch 94, making it possible to adjust the apparatus at multiple tone levels. Therefore, it becomes possible to make more stable the image forming apparatus 100 in terms of the overall density/tone. In the case of the image forming apparatus 100 in this embodiment, the sheet interval patch 94 for black, yellow, magenta, and cyan colors were 0.5 in O.D._{TI} (O.D._{TI}=0.5) and 5 in the width W (W=5).

The reflection density is the value of Dr in the following mathematical equation, in which I0 stands for the amount of light projected upon the reflective surface, and I stands for the amount by which the light is reflected by the reflective surface:

Dr=Log₁₀(I0/I).

Normally, reflection density is obtained by measuring the amount by which a beam of light projected upon a reflective surface at an angle of 45° is reflected in the direction of the normal line of the reflective surface. More concretely, the values obtained by measuring the reflection density of the sheet interval patch 94 with the use of a reflection density measuring device RD-918 (product of Rite Co., Ltd.) In particular, in each embodiment, the reflection density of the image on the first of the consecutively conveyed two sheets of recording medium after the formation of the sheet interval patch 94, is the value obtained by measuring in reflection density the image after the transfer of the image onto the first sheet of paper, but before the fixation of the image to the sheet. In the following description of the embodiments of the present invention, it is stated as if the CPU 306 determines the amount of the refection density. However, there is a specific relationship between the above described reflection density Dr and the amount I by which the light is reflected. Thus, the image forming apparatus 100 may be structured so that the CPU 306 directly determines the amount I by which the light is reflected. Further, the information about this amount of reflected light is equivalent to the information about the density of the sheet interval patch 94.

<Means for Adjusting Image Forming Apparatus in Density during Sheet Intervals>

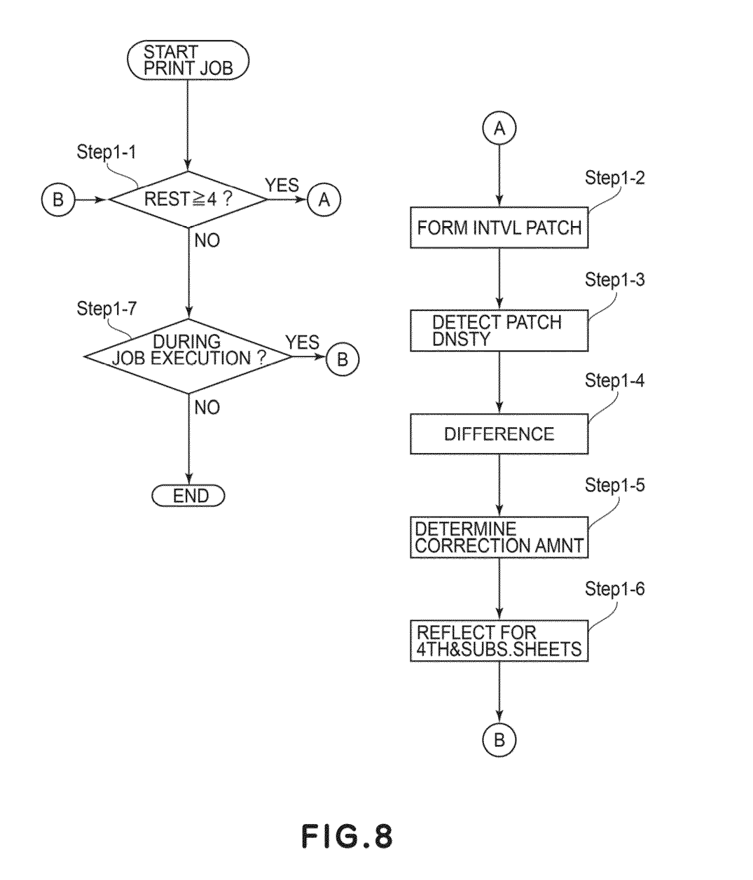

Next, referring to the flowchart in FIG. 8, the method used by the above described CPU 306, which functions as the means for adjusting the image forming apparatus 100 in image density during sheet intervals, in order to successively adjust in density the image forming apparatus 100 by detecting the density of the sheet interval patches 94 formed on the sheet interval portions of the intermediary transferring member 40, is described.

In Step 1-1, as soon as the CPU 306 starts a printing job, it finds out whether or not the remaining number of prints to be outputted for the printing job is no less than four, for the following reason: The image forming apparatus 100 in this embodiment is structured, because of the restrictions in terms of the structure and positioning of its components, so that it is adjusted in density during sheet intervals only when the remaining number of prints to be outputted is no less than a preset value. More concretely, for example, in the case of a printing job in which sheets of paper of size A4 are conveyed in the portrait mode, the image forming apparatus 100 is adjusted in density only when the remaining number of prints is no less than four, for the following reason. That is, at the point in time when the density of the sheet interval patch 94 formed in the interval between the first and second of two sheets of recording medium which are being consecutively conveyed, is detected, the image for the third print will have begun to be formed on the photosensitive drum 50Y, or the most upstream drum 50. Therefore, the print which will be affected by the information about the density adjustment is the fourth print or the prints thereafter. In such a case, however, the color deviation/density control section 308 predicts density changes which might occur to the second and third images (prints), based on the outputs of the temperature/humidity sensor 89, and the information about the cumulative usage of each of the photosensitive drums 50Y, 50M, 50C and 50K, in order to keep the image forming apparatus 100 stable in density.

Next, a case in which the remaining number of prints is no less than four is described. In such a case, the CPU forms sheet interval patches 94 with the use of the toner patch forming means. More concretely, the data of the sheet interval patches 94 shown in FIGS. 5 and 6 are stored in advance in the ROM 310. Thus, the CPU 306 reads the data of the sheet interval patch 94, which is in the ROM 310, and makes the image formation stations 307 sequentially form sheet interval patches 94 based on the sheet interval patch data, with preset timings, in Step 1-2.

In Step 1-3, the density O.D. of each of the sheet interval patches 94, different in color, is detected by the density sensors 90. Then in Step 1-4, the amount of difference between the detected density O.D. of each sheet interval patches 94 and the idealistic (theoretical) densities for each sheet interval patch 94, which is based on the data for the sheet interval patch 94 prepared in advance, is calculated. Then, in Step 1-5, the amount by which the image formation setting is to be adjusted for the fourth print and thereafter is determined. In the case of the image forming apparatus 100 in this embodiment, the so-called proportional control, that is, such control that compensates all at once for the entirety amount of difference between the idealistic (theoretical) density and actually measured density of the sheet interval patch 94, is not carried out. Instead, the proportion/integration control, which is for gradually reducing the difference, is used to determine the amount by which the image formation settings are to be adjusted. The examples of the image formation conditions (settings) to be adjusted are the contents of the table which are stored in the RAM 309 and show the relationship between the image data and the amount by which laser light is to be emitted by the laser scanner, for each color. However, the image formation condition (settings) may be charge bias setting, development bias setting, etc., instead of those mentioned above. Here, the table which shows the amount by which laser light is to be emitted by the laser scanner is for showing the relationship between the image data and the level of intensity at which laser light is to be emitted, or the length of time the laser light is to be emitted by the laser scanner. Needless to say, it is sometimes referred to as an image-density conversion table, or y-table. Then, in Step 1-6, images are formed based on the adjusted image formation condition (settings). Then, the CPU 306 returns to Step 1-1, in which it finds out whether the remaining number of prints to be outputted is no less than four, and the above described operational sequence is repeated until the remaining number of prints to be outputted becomes no more than four.

As the number of the remaining prints to be outputted becomes no more than four, the CPU 306 checks, in Step 1-7, whether the image forming apparatus 100 is still forming an image (images). If the apparatus is still forming an image (images), the CPU 306 returns to Step 1-1. If the apparatus is not forming an image (images), the CPU determines that the printing job has ended.

That is, in this embodiment, when the image forming apparatus 100 is adjusted in image density, by detecting the density of each sheet interval patch 94 during sheet intervals, the sheet interval patches 94 are formed in such a manner that the density of the peripheral portions TO of each sheet interval patch 94 gradually reduces from its inward edge toward its outward edge. Therefore, the image forming apparatus in this embodiment is significantly less in terms of the conspicuousness of the back surface soiling than any image forming apparatus in accordance with the prior art, while remaining as excellent in productivity and stable in image density than any image forming apparatus in accordance with the prior art.

In this embodiment, the smallest value in which the number of the remaining prints to be outputted in a printing job has to be four in order for the information about the density adjustment to be reflected in the ongoing printing operation. This number, however, is affected by the structural factors, such as the distance from the most upstream image formation station, that is, the yellow image forming station, to the density sensors 90, the length of time it takes for the CPU 306 to switch among various processes, and the like, and the size of the sheet of recording medium on which an image is formed. In other words, this embodiment is not intended to limit the present invention in terms of these factors.

Further, in this embodiment, the image forming apparatus 100 is adjusted in density while the sheet interval portion PD of the intermediary transferring member 40 is moving through the secondary transfer station, in a continuous image forming operation. However, this embodiment is not intended to limit the present invention in terms of the timing with which the image forming apparatus 100 is to be adjusted in density. That is, the present invention is also applicable to an electrophotographic image forming apparatus which forms the sheet interval patch 94 (which characterizes the present invention), regardless of the recording medium sheet count.

Further, the present invention is applicable to an electrophotographic image forming apparatus structured so that in a case where the length of time between two consecutive print jobs is short, the apparatus is adjusted in density based on the results of the detection of the sheet interval patch 94 in the first printing job.

Further, in this embodiment, the sheet interval patch 94 was formed so that the density of each of its peripheral portions TO is highest at the inward edge and linearly reduces toward the outward edge. However, the sheet interval patch 94 may be formed so that the density of its peripheral portions TO is highest at the inward edge, and reduces in trigonometric or multidimensional curvature toward the outward edge.

Further, each of the corner portions TO2 shown in FIG. 5 was in the form of a quadrant. However, this embodiment is not intended to limit the present invention in terms of the shape of the corner portion TO2 of the sheet interval patch 94. For example, the corner portion TO2 may be in the form of a triangle.

Also in this embodiment, four sheet interval patches 94 (94(T-Y), 94(T-M), 94(T-C) and 94(T-K)) which correspond to four primary colors, one for one, are formed on the sheet interval portion PD of the intermediary transferring member 40 as shown in FIG. 4. However, this embodiment is not intended to limit the present invention. That is, in a case where an electrophotographic image forming apparatus tends to relatively quickly change in density, and therefore, needs to be adjusted realtime in density, it is necessary to adjust the apparatus in density with the use the fixed toner patch with relatively high frequency as in this embodiment. However, in the case where an image forming apparatus which tends to slowly change (deviate) in density, and the apparatus is wanted to remain stable in density/toner characteristic, it is recommendable to adjust the apparatus in the following manner.

That is, an image forming apparatus may be adjusted in image density, based on image tone, by forming sheet interval patches different in tone, in each sheet interval portion of the intermediary transferring member 40. Further, there are cases in which an image forming apparatus slowly changes in image density, in long term, while frequently and cyclically changing in short term. In such cases, all that is necessary is to use the average value in tone of the multiple sheet interval patches which are formed one for one in multiple sheet interval portions of the intermediary transferring member 40, so that the short and cyclical components can be ignored.

Further, if the standpoint of reducing the amount by which toner is consumed during the normal image forming operation is taken into consideration, in addition to the above described factors, it is also effective to change the sheet interval patch 94 in the width W of its peripheral portions TO according to the density of the sheet interval patch 94 in use, based on the results of the experiments given in FIG. 7. More concretely, in this embodiment, if the sheet interval patch 94 in use is 0.5 in density (O.D._{TI}=0.5), the sheet interval patch 94 was formed so that the width W becomes 5 (W=5). However, when the sheet interval patch 94 is formed so that it is less in density, it may be formed so that its peripheral portions TO are less in width W. For example, when the sheet interval patch 94 is formed so that the density O.D._{TI} of the center portion of the sheet interval patch 94 become 0.3 (O.D._{TI}=3), its peripheral portions TO also will be no more than 0.3 in density. Therefore, it may be formed so that its peripheral portions TO, which will be at the level 1 in terms of permissibility in terms of back surface soiling, will become 3 mm in the width W (W=3). Further, in a case where the sheet interval patch 94 formed on the portion of the intermediary transferring member 40, which is between the consecutively conveyed two sheets of recording medium, does not overlap with the second sheet, it is unnecessary to form the sheet interval patch 94 so that it will have the peripheral portions TO. By operating the image forming apparatus as described above, it is possible to reduce the apparatus in toner consumption, which keeping it as excellent in productivity and stable in density as any image forming apparatus in accordance with the prior art.

### Embodiment 2

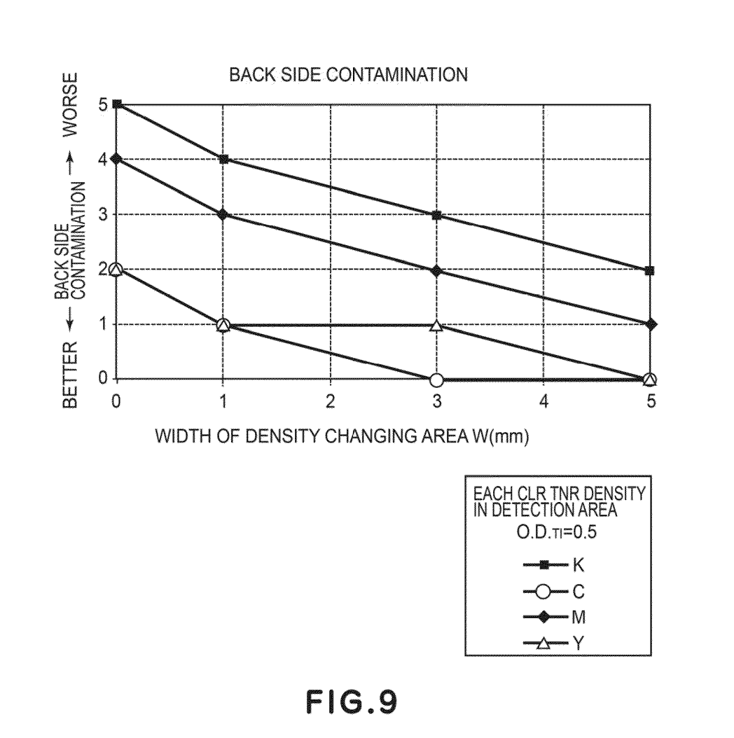

Next, referring to FIG. 9, the image forming apparatus in the second embodiment of the present invention is described. The image forming apparatus in this embodiment is an improved version of the image forming apparatus in the first embodiment. That is, it is less in toner consumption than the apparatus in the first embodiment, while remaining just as excellent in productivity and stable in density as the apparatus in the first embodiment. The image forming apparatus in this embodiment is less in toner consumption because of the manner in which it forms the peripheral portions TO of the sheet interval patch 94. Most of the hardware portions of the image forming apparatus in this embodiment are the same as the counterparts of the image forming apparatus in the first embodiment, and therefore, are not going to be described here. That is, the image forming apparatus in this embodiment is operated following virtually the same flowchart as the flowchart, in the first embodiment, of the operation for adjusting the image forming apparatus in density by forming the sheet interval patch 94 on the sheet interval portion of the intermediary transferring member 40, and detecting the density of the sheet interval patch 94. That is, the only difference between the first and second embodiment is the data for the sheet interval patch 94 stored in the ROM 310, and therefore, only the difference is described in detail. In the case of the image forming apparatus in this embodiment, it is afforded more latitude in terms of the adjustment of its density during sheet intervals, by making the sheet interval patches 94 for four primary colors different in the structure of the peripheral portions TO, based on the fact that the smaller the amount of the difference in color between the color of a sheet P of recording medium (paper) and that of the sheet interval patch 94, the less conspicuous the back surface soiling the sheet P.

### <Structure of Sheet Interval Patch>

FIG. 9 is a graph that shows the results of experiments in which the sheet interval patches 94 were kept the same in the density (O.D._{TI}) of the density detection area TI of the sheet interval patches 94 for all colors, that is, cyan (C), magenta (M), yellow (Y) and black (K) colors, but, they were made different in the density (O.D._{TO}) of the peripheral portions TO, based on the color. It shows the relationship between the visual ranking of the back surface soiling, and the width W of the peripheral portions TO of the sheet interval patch 94, for cyan (C), magenta (M), yellow (Y) and black (K) colors. The back surface soiling was visually ranked immediately after a full rotation of the secondary transfer roller 60a. The explanation of FIG. 9 is the same as that of FIG. 7 which concerns the first embodiment, and therefore, is not going to be given here. As will be evident from the graph, the visual ranking of the back surface soiling is affected by the color of the sheet interval patch 94. That is, the visual ranking of the sheet interval patches 94 made of the cyan (C), yellow (Y), magenta (M) and black (K) toners, corresponds to the order in which they are listed; the yellow sheet interval path 94 is lowest in visual ranking, and the black sheet interval patch 94 is highest in visual ranking. As for the color difference ΔE94 (CIE1994 Chrominance Formula: Color Difference Evaluation, CIE Technical Report, 116.) between the sheets of recording paper (Copier/Laser Printer Paper CS814: product of Canon, Co., Ltd.) and the center portion of the sheet interval patch 94, are given in Table 1. That is, there is a correlation between the conspicuousness of the back surface soiling and color.

TABLE 1

| Back side contamination | ← Lower | | Higher → | |
|---|---|---|---|---|
| Toner color | C | Y | M | K |
| ΔE94 | 28.5 | 29.5 | 34.6 | 36.3 |

That is, it can be said that the smaller the color difference (chrominance) between a sheet of recording medium (paper) and the sheet interval patch 94, the less conspicuous the back surface soiling, affording more latitude when adjusting the image forming apparatus in image density.

The image forming apparatus uses the sheet interval patch 94 which is characterized as described above. It uses a sheet interval patch 94 such as those shown in Table 2. The density O.D._{TI} of the density detection area TI of the sheet interval patch 94 and the width W of the peripheral portions TO of the sheet interval patch 94 are the same in amount as those mentioned in the description of the first embodiment, and given in FIG. 5. The data of each of the sheet interval patches 94 which are different in color (yellow, magenta, cyan and black) and size, and are set in specifications in advance according to Table 2 are stored in the ROM 310. Thus, the CPU forms sheet interval patches 94 by controlling the image formation stations 307, based on the sheet interval patch data stored in the ROM 310, as in the first embodiment.

In the case of a printing job which is large in print count, it is possible that a sheet interval patch 94 will be formed on a portion of the intermediary transferring member 40, across which a sheet interval patch 94 was present (formed and removed). In this embodiment, therefore, the image forming apparatus is designed to form the sheet interval patches 94 in such a manner that the four sheet interval patches 94, different in color, are positioned so that the yellow and magenta sheet interval patches 94 align in the recording medium conveyance direction, and the cyan and black sheet interval patches 94 align in the recording medium conveyance direction, that is, so that the paired sheet intervals patches 94 are smallest in the color difference between the recording medium and sheet interval patch 94, as shown in FIG. 4. That is, the order in which the four sheet interval patches 94 are formed by the image formation stations 307 in Step 1-2 described with reference to FIG. 8, is set so that the yellow and magenta sheet interval patches 94 align in the recording medium conveyance direction, and the cyan and black sheet interval patches 94 align in the recording medium conveyance direction. In the case where the four sheet interval patches 94 are different in density, they are formed so that the color difference between the recording medium and sheet interval patch 94 will become smallest, in consideration of the fact that the chromaticity is affected by density.

TABLE 2

| Toner | | W |
|---|---|---|
| color | O.D._{TI} | (mm) |
| K | 0.5 | 5 |
| C | 0.5 | 0 |
| M | 0.5 | 3 |
| Y | 0.5 | 0 |

As described above, in this embodiment, when the image forming apparatus is adjusted in density during sheet intervals, by detecting the density of the sheet interval patches 94 it forms on the sheet interval portion of the intermediary transferring member 40, it forms the four sheet interval patches 94, different in color, so that the sheet interval patches 94 become different in the width W of their peripheral portions TO. Thus, the image forming apparatus is significantly less in the amount of the toner used for the formation of the peripheral portions TO of each sheet interval patch 94, than the image forming apparatus in the first embodiment, while remaining as excellent in productivity and stable in image density as the image forming apparatus in the first embodiment.

### Embodiment 3

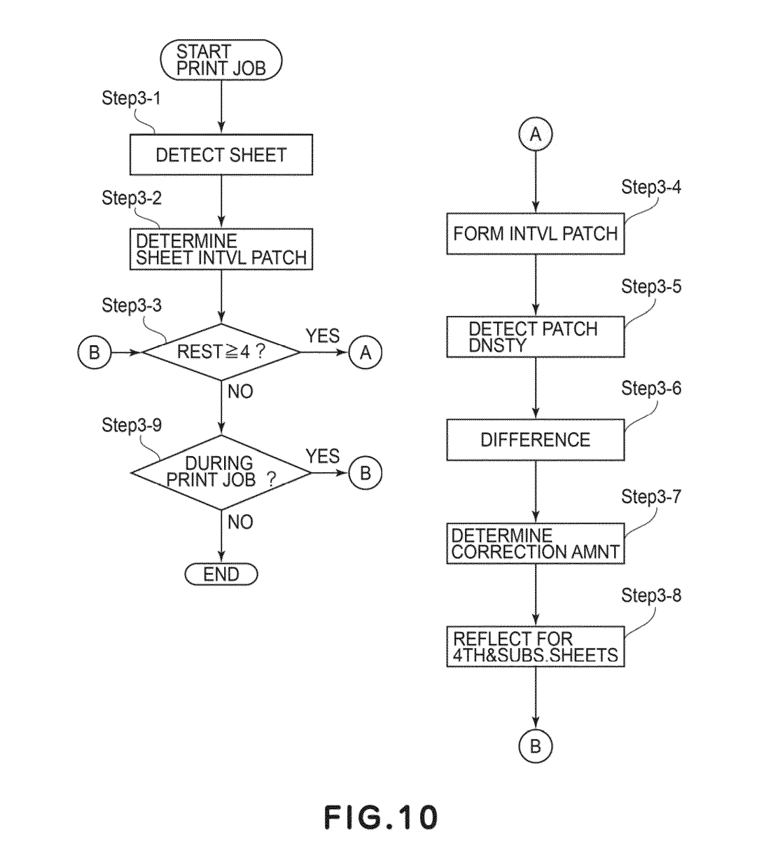

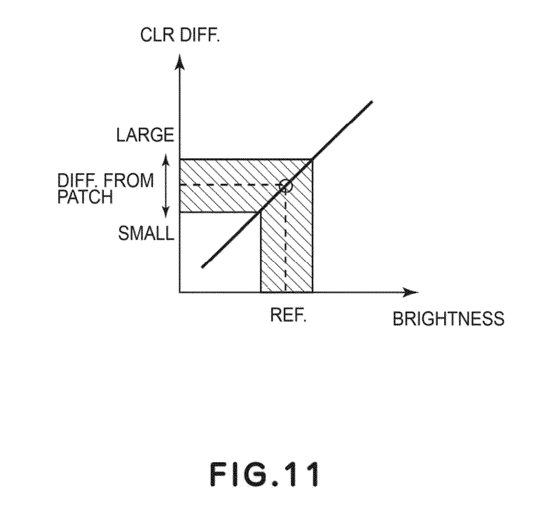

Next, referring to FIGS. 10 and 11, the third embodiment of the present invention is described. The image forming apparatus in this embodiment is an improved version of the one in the second embodiment. Not only is it less in toner consumption than the one in the first embodiment while remaining as excellent in productivity and stable in image density as the one in the first embodiment, but also, it remain as excellent as the one in the first embodiment, even if recording medium is switched in type. The structure of the image forming apparatus in this embodiment is the same as that in the first embodiment, and therefore, is not described here. This embodiment is different from the first and second embodiments in that in the case of the image forming apparatus in this embodiment, the CPU 306 shown in FIG. 2 is enabled to predict the color difference between a sheet P of recording medium and the sheet interval patch 94 to be formed, based on the information (recording medium type) obtained by the media sensor 88, and form the sheet interval patch 94 so that the sheet interval patch 94 reflects the information obtained by the media sensor 88.

### <Means for Adjusting Image Forming Apparatus in Image Density During Sheet Intervals>

Next, referring to the flowchart in FIG. 10, the operation for adjusting the image forming apparatus in image density while the sheet interval portion PD of a sheet P of recording medium is in the secondary transfer station 60 is described. In Step 3-1, the media sensor 88 (color difference obtaining means) detects the brightness (prior to secondary transfer) of the sheet P while the sheet P is temporarily kept stationary by the pair of registration rollers 34, as soon as a printing job is started. Here, the “brightness” is information that indicates the brightness (reflectivity) of the sheet P (medium onto which image is transferred). Needless to say, therefore, the information may be substituted by any parameter similar to the brightness. Then, in Step 3-2, the CPU 306 predicts by computation based on the brightness of the sheet P obtained by the media sensor 88, the chrominance between the sheet P and the sheet interval patch 94 which is to be formed on the next sheet interval portion PD of the intermediary transferring member 40, and sets how the peripheral portions TO of the next sheet interval patch 94 is to be formed.

FIG. 11 is a drawing for describing the relationship between the brightness of a sheet P of recording medium, and the color difference between the sheet P and sheet interval patch 94. There is a correlation between the brightness of the sheet P detected by the media sensor 88, and the color difference between the sheet P and sheet interval patch 94. In the case of the image forming apparatus in this embodiment, therefore, the value (which hereafter will be referred to as “referential value”) of the standard (referential) recording medium detected by the media sensor 88 is stored in the ROM 310, and each time a sheet P of recording medium is fed into the main assembly of the image forming apparatus, its brightness detected by the media sensor 88 is compared to the referential value. More concretely, the range in which the output of the media sensor 88 will be when the amount of color difference, which corresponds to one visual ranking, with reference to the back surface soiling of a sheet of standard recording medium, is stored in the ROM 310, and the hatched area in FIG. 11, the center of which corresponds to the referential value, is compared to the value detected by the media sensor 88.

In the second embodiment, the sheet interval patch 94 pattern, which corresponds to the visual ranking 2 in FIG. 9, was used as the design for the sheet interval patch 94. In comparison, in this embodiment, when the recording medium to be used for a print job is such a medium that will make the color difference between itself and sheet interval patch 94 large, and therefore, makes the back surface soiling more conspicuous, the sheet interval patch 94 is switched in design from the one which corresponds to the visual ranking 2 to the one which corresponds to the visual ranking 1, that is, it is raised by one step in visual ranking. On the other hand, when the recording medium to be used for a printing job is such recording medium that reduces the color difference between itself and sheet interval patch 94, and therefore, makes the back surface soiling less conspicuous, the sheet interval patch 94 is switched in design from the one which corresponds to the visual ranking 3, that is, the one which is one ranking lower than the standard one. More concretely, the sheet interval patches 94 are formed as shown in Table 3.

TABLE 3

| Increasing | | | Decreasing | | |
|---|---|---|---|---|---|
| Color Difference | | | Color Difference | | |
| Case (Rank 1) | | | Case (Rank 3) | | |
| Toner | | W | Toner | | W |
| Color | O.D._{TI} | (mm) | Color | O.D._{TI} | (mm) |
| K | 0.4 | 5 | K | 0.5 | 3 |
| C | 0.5 | 1 | C | 0.7 | 0 |
| M | 0.5 | 5 | M | 0.5 | 1 |
| Y | 0.5 | 1 | Y | 0.7 | 0 |

The steps which follows the Step 3-2 are the same as Step 1-1-Step 1-7 described in the description of the first embodiment, and therefore, are not going to described here.

As described above, in this embodiment, when forming the sheet interval patch 94 to adjust the image forming apparatus in image density, based on the detected density of the sheet interval patch 94 formed on the sheet interval portion of the intermediary transferring member 40, the density for the density detection area TI of the sheet interval patch 94, the density for the peripheral portions TO of the sheet interval patch 94, and the dimension of the peripheral portions TO of the sheet interval patch 94, are set according to the recording medium type. Therefore, the image forming apparatus in this embodiment is less in toner consumption than that in the second embodiment, while remaining as excellent in productivity and stable in image density as those in the first and second embodiments.

The second embodiment is not intended to limit the present invention in structure. That is, the present invention is also applicable to an electrophotographic image forming apparatus, the color difference detecting means of which is a color sensor capable of detecting the density or chromaticity of the color patch on a sheet of recording medium after the fixation of the color patch. In the case of such an image forming apparatus, a sheet P of recording medium and sheet interval patch 94 are detected in chromaticity, that is, the color difference is actually measured in stead of being predicted, and the sheet interval patch 94 is formed so that it reflects the actual color difference between a sheet of recording medium and the fixed sheet interval patch 94 on the sheet.

### Embodiment 4

Next, the fourth embodiment of the present invention is described. The image forming apparatus in this embodiment is an improved version of the image forming apparatus in the third embodiment. This embodiment is the same as the second and third embodiments in terms of the structure of the image forming apparatus, and also, in terms of the flowchart for the operational sequence for adjusting the image forming apparatus in image density during sheet intervals. Therefore, these aspects of this embodiment are not going to be described here. The difference of this embodiment from the second and third embodiments is that the CPU 306 shown in FIG. 2 forms the sheet interval patches 94 in such a manner that the sheet interval patches 94 reflect not only the information obtained by the media sensor 88, but also, the information obtained by the temperature/humidity sensor 89 and the information stored in the RAM 309 about the cumulative length of usage of the photosensitive drums 50Y, 50M, 50C and 50K. That is, in this embodiment, the CPU is enabled to form the sheet interval patches 94 in such a manner that the sheet interval patches 94 reflect not only the recording medium color, but also, the length of usage of each photosensitive drum 50. In comparison to the image forming apparatuses in the second and third embodiment, which paid attention to only the predictable color difference between the recording medium and the sheet interval patch 94 to be formed, the image forming apparatus in this embodiment pays attention to the efficiency with which each sheet interval patch 94 is transferred onto the secondary transfer roller 60a (secondary transfer), and/or the efficiency with which the toner on the secondary transfer roller 60a (toner having soiled secondary transfer roller 60a) is transferred (retransfer) onto the back surface of the N-th sheet of recording medium. More concretely, it is primarily the electrical field in the secondary transfer unit T2 that makes the toner of the sheet interval patch 94 on the intermediary transferring member 40 transfer onto the secondary transfer roller 60a when the sheet interval patch 94 is in the secondary transfer station 60. Then, as the secondary transfer roller 60a rotates a full turn, and therefore, the toner from the sheet interval patch 94 reaches the back surface of the N-th sheet of recording medium, the toner from the sheet interval patch 94 is transferred onto the back surface of the N-th sheet in the same manner as an ordinary image is transferred onto a sheet P of recording medium (secondary transfer). Therefore, there is the sheet P between the secondary transfer roller 60a and intermediary transferring member 40. Therefore, it has to be taken into consideration that the toner in the sheet interval patch 94 is transferred not only by the electric field, but also, through the physical contact between the secondary transfer roller 60a and the sheet P.

In the case of an electrophotographic image forming apparatus, the toner in its developing device deteriorates in the characteristic related to electric charge. Normally, this deterioration is related to the history of the usage of the apparatus (cumulative length of usage/state of deterioration/ratio of cumulative length of usage to service life). More specifically, it is thought that when the apparatus is in use, the toner in the developing device is damaged by the high temperature in the apparatus, and agglomerates, and/or the external additive to the toner, which enables toner particles to become electrically charged, is buried into the toner particles by the unnecessary amount of friction among the toner particles. Thus, it sometimes occurs that the efficiency with which the toner of the sheet interval patch 94 is transferred onto the secondary transfer roller 60a, and the efficiency with which the toner on the secondary transfer roller 60a is transferred onto the back surface of the N-th sheet of recording medium, change depending on the history of the usage of the image forming apparatus, as well as the method used to control the secondary transfer station 60.

In consideration of these issues described above, the image forming apparatus may be designed so that the sheet interval patch 94 is formed in such a manner that the density of the density detection area TI of the sheet interval patch 94, density of the peripheral portions TO of the sheet interval patch 94, and width W of the peripheral portions TO of the sheet interval patch 94 reflect the information about the history of the usage of each of the photosensitive drums 50Y, 50M, 50C and 50K, which is stored in the RAM, in addition to the information about the ambient temperature and humidity obtained by the temperature/humidity sensor 88, and the color of recoding medium. More concretely, when an electrostatic image forming apparatus is operated in an environment which is high in temperature and humidity, toner tends to absorb moisture, and therefore, deteriorate in terms of its ability to become electrically charged. Thus, in an environment which is high in temperature and humidity, toner tends to easily transfer than in the normal environment, even if the transfer electric field is kept the same in strength, making it highly possible for the back surface of a sheet of recording medium to be soiled with toner. Thus, in this embodiment, when the apparatus is operated in an environment which is high in temperature and humidity, such sheet interval patch 94 that is lower in the toner density of its density detection area TI and peripheral portions TO, or greater in the width W of its peripheral portions TO, is formed.

As for the toner transfer from the secondary transfer roller 60a onto a sheet P of recording medium, which is caused by the physical contact between the secondary transfer roller 60a and the sheet P, it has a strong correlation to the surface roughness of the sheet P. Thus, the image forming apparatus may be designed so that the density O.D._{TI} of the detection area TI of the sheet interval patch 94, the density O.D._{TO} of the peripheral portions TO of the sheet interval patch 94, and the width W of the peripheral portions TO of the sheet interval patch 94 reflect the information about the surface roughness of the sheet P. More concretely, when a sheet of recording medium, such as a sheet of paper, the surface of which is rough, is used as recording medium, the data for the sheet interval patch 94 is modified so that the sheet interval patch 94 becomes lower in the density O.D._{TI} of its density detection area TI and the density O.D._{TO} of its peripheral portions TO is formed, or becomes greater in the width W of its peripheral portions TO.

That is, the sheet interval patch 94 may be formed so that the density O.D._{TI} of its density detection area TI, the density O.D._{TO} of its peripheral portions TO, and the width W of its peripheral portions TO reflect the efficiency with which the sheet interval patch 94 is transferred onto the secondary transfer roller 60a, the efficiency with which the toner on the secondary transfer roller 60a is transferred onto the back surface of the N-th sheet of recording medium, which are predicted based on the history of the usage of the image forming apparatus, the environment in which the apparatus is being used, and the information about the recording medium being used for the ongoing printing job. By forming the sheet interval patch 94 as described above, it is possible to make the apparatus significantly smaller in toner consumption than the apparatuses in the preceding embodiments, while keeping the apparatus as excellent in productive and stable in image density as the apparatuses in the preceding embodiments.

In the first to fourth embodiments of the present invention, the image forming apparatus of the so-called tandem type. However, the present invention is also applicable to an image forming apparatus different in structure and image forming method from those in the preceding embodiments, as long as they use an intermediary transfer member. For example, the present invention is also applicable to an image forming apparatus of the so-called four-pass image forming method. Further, in the preceding embodiments, the intermediary transfer member was in the form of an endless belt. However, the present invention is also applicable to an image forming apparatus which uses an intermediary transfer member which is in the form of a drum.

While the invention has been described with reference to the structures disclosed herein, it is not confined to the details set forth, and this application is intended to cover such modifications or changes as may come within the purposes of the improvements or the scope of the following claims.

This application claims priority from Japanese Patent Application No. 261017/2011 filed Nov. 29, 2011, which is hereby incorporated by reference.

What is claimed is:

1. An image forming apparatus comprising:
an intermediary transfer member for carrying an image formed by image forming means;
secondary transferring means for transferring the image from said intermediary transfer member onto a recording material;
toner patch forming means for forming a toner patch for a density adjustment between adjacent recording materials, in an area corresponding to between adjacent ones of recording materials in continuous image formation on said intermediary transfer member, by controlling said image forming means;
density detecting means for detecting density information of the toner patch; and
a sheet interval density adjusting means for adjusting substantially in real time a density/tone-gradation property of the image formed by said image forming means on the basis of a detection result of said density detecting means,
wherein the toner patch includes a density detection area a density of which is detected, and a marginal portion provided at a outer marginal portion of the density detection area and having a density lower than that of the density detection area, and
wherein said toner patch forming means changes at least one of a patch image density of the density detection area, a size of the marginal portion and a density of the marginal portion.

2. An apparatus according to claim 1, wherein the density of the marginal portion stepwisely decreases from a density of the density detection area in accordance with a distance from an end portion of the density detection area.

3. An apparatus according to claim 1, wherein said toner patch forming means changes a size of a marginal portion of the patch in accordance with a patch image density of the density detection area.

4. An apparatus according to claim 1, further comprising color difference obtaining means for deducing or measuring a color difference between the recording material and the density detection area of the toner patch, wherein at least one of a patch image density of the density detection area, a size of the patch marginal portion and a density of the patch marginal portion is changed in accordance with the color difference provided by said color difference obtaining means.

5. An apparatus according to claim 4, wherein said color difference obtaining means includes a media sensor for discriminating a kind of the recording material prior to image transfer.

6. An apparatus according to claim 4, wherein said color difference obtaining means includes a color sensor capable of detecting a chromaticity of the recording material and the image on the recording material after image fixing.

7. An apparatus according to claim 1, further comprising at least one of a temperature/humidity sensor for detecting ambient temperature/humidity inside or outside said apparatus, a storing device for storing a use state of a constituent element of said apparatus and a recording material surface roughness sensor for detecting a surface roughness of the recording material, wherein at least one of a patch image density of the density detection area and a size or density of the marginal portion is changed on the basis of at least one of a detection result of said temperature/humidity sensor, information stored in the storing device and a result of surface roughness detection of the recording material.

8. An image forming apparatus comprising:
an intermediary transfer member for carrying an image formed by image forming means;
secondary transferring means for transferring the image from said intermediary transfer member onto a recording material;
toner patch forming means for forming a toner patch for a density adjustment between adjacent recording materials, in an area corresponding to between adjacent ones of recording materials in continuous image formation on said intermediary transfer member, by controlling said image forming means;
density detecting means for detecting density information of the toner patch;
a sheet interval density adjusting means for adjusting substantially in real time a density/tone-gradation property of the image formed by said image forming means on the basis of a detection result of said density detecting means, and
color difference obtaining means for deducing or measuring a color difference between the recording material and the density detection area of the toner patch,
wherein the toner patch includes a density detection area a density of which is detected, and a marginal portion provided at a outer marginal portion of the density detection area and having a density lower than that of the density detection area, and wherein at least one of a patch image density of the density detection area, a size of the patch marginal portion and a density of the patch marginal portion is changed in accordance with the color difference provided by said color difference obtaining means.

9. An apparatus according to claim 8, wherein the density of the marginal portion stepwisely decreases from a density of the density detection area in accordance with a distance from an end portion of the density detection area.

10. An apparatus according to claim 8, wherein said toner patch forming means changes a size of the of a marginal portion of the patch in accordance with a patch image density of the density detection area.

11. An apparatus according to claim 8, wherein said color difference obtaining means includes a media sensor for discriminating a kind of the recording material prior to image transfer.

12. An apparatus according to claim 8, wherein said color difference obtaining means includes a color sensor capable of detecting a chromaticity of the recording material and the image on the recording material after image fixing.

13. An apparatus according to claim 8, wherein at least one of a temperature/humidity sensor for detecting ambient temperature/humidity inside or outside said apparatus, a storing device for storing a use state of a constituent element of said apparatus and a recording material surface roughness sensor for detecting a surface roughness of the recording material, wherein at least one of a patch image density of the density detection area and a size or density of the marginal portion is changed on the basis of at least one of a detection result of said temperature/humidity sensor, information stored in the storing device and a result of surface roughness detection of the recording material.
